(19) United States
(12) Patent Application Publication
(10) Pub. No.: US 2019/0168106 A1
(43) Pub. Date: Jun. 6, 2019

(54) INTERACTIVE TEACHING TOOL FOR BILLIARDS

(71) Applicant: Garth CARTWRIGHT, Dwight, IL (US)

(72) Inventor: Garth CARTWRIGHT, Dwight, IL (US)

(21) Appl. No.: 16/195,640

(22) Filed: Nov. 19, 2018

Related U.S. Application Data
(60) Provisional application No. 62/593,677, filed on Dec. 1, 2017.

(51) Int. Cl. A63D 15/00; G06F 3/0484

(52) U.S. Cl. CPC A63D 15/006; G06F 3/0484

(57) ABSTRACT

A billiard aiming system includes a housing configured to be mounted to a ceiling above a billiards table; at least one sensor positioned within the housing and configured to detect a position and an identity of at least one object on a playing surface of the billiards table; and a projector positioned in visual communication with the billiards table and configured to project a grid on the playing surface of the billiards table. A system for teaching billiards includes a billiards table having a playing surface; the billiard aiming system, and a mobile device having a graphical user interface. The mobile device is configured to receive geometric data and identification data from the billiard aiming system and display instructions regarding a suggested shot trajectory on the graphical user interface based on the geometric data and the identification data.

### CROSS-REFERENCE TO RELATED APPLICATIONS

This application claims priority to U.S. Provisional Application No. 62/593,677, filed Dec. 1, 2017, which is incorporated herein by reference in its entirety for all purposes.

### FIELD

The present application relates generally to the field of billiards. More specifically the present disclosure relates to an interactive teaching tool including a grid configured to assist a user in lining up a shot on a billiards table.

The game of pocket billiards includes the following equipment: a pocket billiards table, a cue ball, a number of object balls, and an elongated stick. A traditional pocket billiards table is comprised of a flat-surface playing field covered in a cloth fabric, a number of raised rails surrounding the perimeter of the playing field, and a number of pockets situated about the perimeter of the playing field. Traditionally, the playing field of a pocket billiards table is rectangular in shape and there are six total pockets on the table—one pocket located in each of the four corners and one pocket located in the center of each of the two longer sides of the table. Such pockets are set within a frame of the pocket billiards table in such a way that allows for object balls located on the playing field to roll and sink into the pockets. A number of different billiard games may be played on pocket billiards tables such as 8-Ball, 9-Ball, straight pool, and snooker. While each game is made up of its own set of rules, the general objective is to sink a particular object ball into one of the table pockets by using an elongated stick to strike the target object ball with a cue ball.

Billiards is similar to pocket billiards, except that a billiards table does not include pockets. Instead, the object of billiards is to use a cue ball to push a striker ball into an opponent's cue ball.

When playing pocket billiards or billiards, it may be difficult for a player to visualize a shot and calculate a shot angle and trajectory. Therefore, a need exists for improved technology, including an interactive visual aid technology that would help players identify shot trajectories and conceptualize shot strategies necessary to proficiently pocket an object ball or strike an opponent's cue ball.

### SUMMARY OF THE INVENTION

An exemplary embodiment relates to a billiard aiming system comprising: a housing configured to be mounted to a ceiling above a billiards table; at least one sensor positioned within the housing and configured to detect a position and an identity of at least one object on a playing surface of the billiards table; and a projector positioned in visual communication with the billiards table and configured to project a grid on the playing surface of the billiards table. The at least one sensor and the projector are contained in the housing.

In some aspects of the exemplary embodiment of the billiard aiming system, the at least one sensor may comprise a line sensor, a light sensor, an infrared sensor, an ultrasonic sensor, a color sensor, an image sensor, or a combination thereof

In some aspects of the exemplary embodiment of the billiard aiming system, the at least one sensor may be configured to detect a color and a pattern of the at least one object on the playing surface of the billiards table. For example, the pattern may comprise a solid pattern or a striped pattern.

An exemplary embodiment relates to a system for teaching billiards comprising: a billiards table having a playing surface; the billiard aiming system described above with respect to the exemplary embodiment of the billiard aiming system and any aspects thereof and a mobile device having a graphical user interface. The mobile device may be configured to receive geometric data and identification data from the billiard aiming system and display instructions regarding a suggested shot trajectory on the graphical user interface based on the geometric data and the identification data.

In some aspects of the exemplary embodiment of the system for teaching billiards, the billiards table may include a plurality of indicators and a plurality of pockets spaced along a periphery of the billiards table. The at least one sensor may be configured to detect the location and the identity of a plurality of objects on the playing surface of the billiards table, the objects comprising at least one object ball and a cue ball. The geometric data may comprise a position of at least one of the indicators, the cue ball, the at least one object ball, or the pockets.

In some aspects of the exemplary embodiment of the system for teaching billiards, the identification data may comprise a color and a pattern of the cue ball or the at least one object ball. For example, the pattern may comprise a solid pattern or a striped pattern.

In some aspects of the exemplary embodiment of the system for teaching billiards, a size and a shape of the grid may be adjustable to cover the playing surface of the billiards table.

In some aspects of the exemplary embodiment of the system for teaching billiards, the projector may be further configured to project a numbering system on at least a first rail of the billiards table and a second rail of the billiards table opposite to the first rail. Numbers on the first rail may increase from a first pocket of the first rail to a midpoint of the first rail by a first predetermined increment, and may decrease from the midpoint of the first rail to a second pocket of the first rail by the first predetermined increment. Numbers on the second rail may increase from a first pocket of the second rail to a midpoint of the second rail by a second predetermined increment, and may decrease from the midpoint of the second rail to a second pocket of the second rail by the second predetermined increment. In some aspects, the first predetermined increment may not equal to the second predetermined increment.

In some aspects of the exemplary embodiment of the system for teaching billiards, the billiard aiming system may be configured to communicate the geometric data and the identification data to the mobile device through a wireless connection.

An exemplary embodiment relates to a method of operating a billiard aiming system (such as the billiard aiming system described above with respect to the exemplary embodiment of the billiard aiming system or system for teaching billiards and any aspects thereof). The method comprises the steps of: projecting a grid onto a playing surface of a billiards table using a projector positioned in visual communication with the billiards table; detecting geometric data and identification data using at least one sensor positioned within a housing mounted to a ceiling above the billiards table; transmitting the geometric data and identification data to a processor in a mobile device; processing, using the processor, the geometric data and identification data to identify a suggested shot trajectory; and displaying instructions regarding the suggested shot trajectory on a display of the user device.

In some aspects of the exemplary embodiment of the method of operating the billiard aiming system, displaying instructions may comprise identifying gridlines of the grid to be used to line up a shot.

In some aspects of the exemplary embodiment of the method of operating the billiard aiming system, detecting geometric data and identification data may comprise detecting a location and an identity of a plurality of objects on the playing surface of the billiards table, the objects comprising at least one object ball and a cue ball.

In some aspects of the exemplary embodiment of the method of operating the billiard aiming system, the billiards table may include a plurality of indicators and a plurality of pockets spaced along a periphery of the billiards table. The method may further comprise detecting geometric data further comprises detecting a position of at least one of the indicators or the pockets.

In some aspects of the exemplary embodiment of the method of operating the billiard aiming system, the identification data may comprise a color and a pattern of the cue ball or the at least one object ball. The pattern may comprise a solid pattern or a striped pattern.

In some aspects of the exemplary embodiment of the method of operating the billiard aiming system, processing the geometric data and identification data may comprise using machine learning or artificial intelligence to identify the suggested shot trajectory.

In some aspects of the exemplary embodiment of the method of operating the billiard aiming system, the method may further comprise projecting a numbering system on at least a first rail of the billiards table and a second rail of the billiards table opposite to the first rail, wherein numbers on the first rail may increase from a first pocket of the first rail to a midpoint of the first rail by a first predetermined increment, and may decrease from the midpoint of the first rail to a second pocket of the first rail by the first predetermined increment; numbers on the second rail may increase from a first pocket of the second rail to a midpoint of the second rail by a second predetermined increment, and may decrease from the midpoint of the second rail to a second pocket of the second rail by the second predetermined increment; and the first predetermined increment may not be equal to the second predetermined increment.

One of ordinary skill in the art would appreciate that the aspects described above are not mutually exclusive and may be combined.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

These and other features, aspects and advantages of the disclosed embodiments will become apparent from the following description and the accompanying exemplary embodiments shown in the drawings, which are briefly described below.

FIG. 1 illustrates a billiard aiming system mounted above a billiards table.

FIG. 2 schematically illustrates components of the billiard aiming system of FIG. 1.

FIG. 3 schematically illustrates components of a computing device of the billiard aiming system of FIG. 1.

FIG. 4 illustrates an example of the billiards table of FIG. 1.

FIG. 5 illustrates an example of a mobile device that can be used in conjunction with the billiard aiming system of FIG. 1.

FIG. 6 is a schematic illustration of communication between the billiard aiming system of FIG. 1, a billiards table, and a mobile device.

FIG. 7 identifies steps in a method of using the billiard aiming system of FIG. 1.

FIG. 8 illustrates an example of indicators, gridlines, and pockets that may be referenced in instructions generated by the billiard aiming system of FIG. 1 and displayed on a user interface of a mobile device.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology is for the purpose of description only and should not be regarded as limiting. An effort has been made to use the same or like reference numbers throughout the drawings to refer to the same or like parts.

While the examples used to describe the billiard aiming system described below are directed to a pocket billiards game, the billiard aiming system may alternatively be used in a billiards game (i.e., on a billiards table that does not include pockets).

Billiard Aiming System

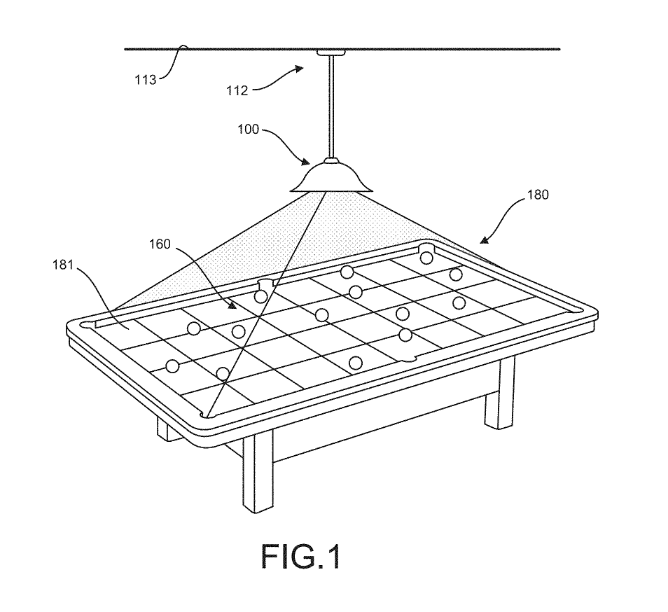

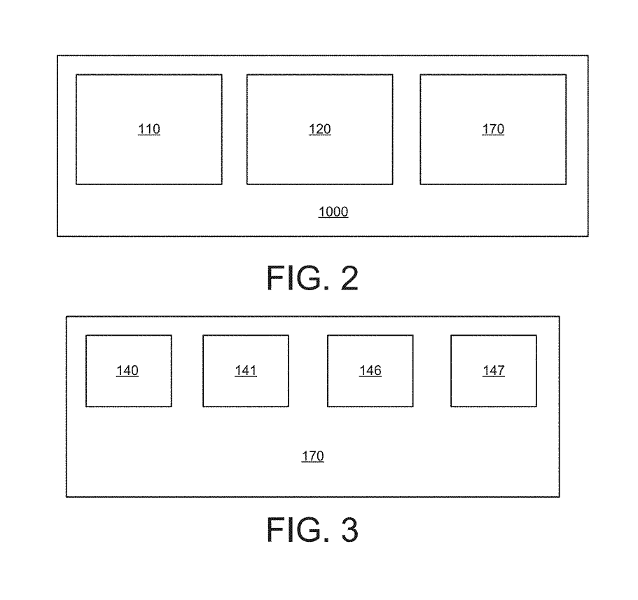

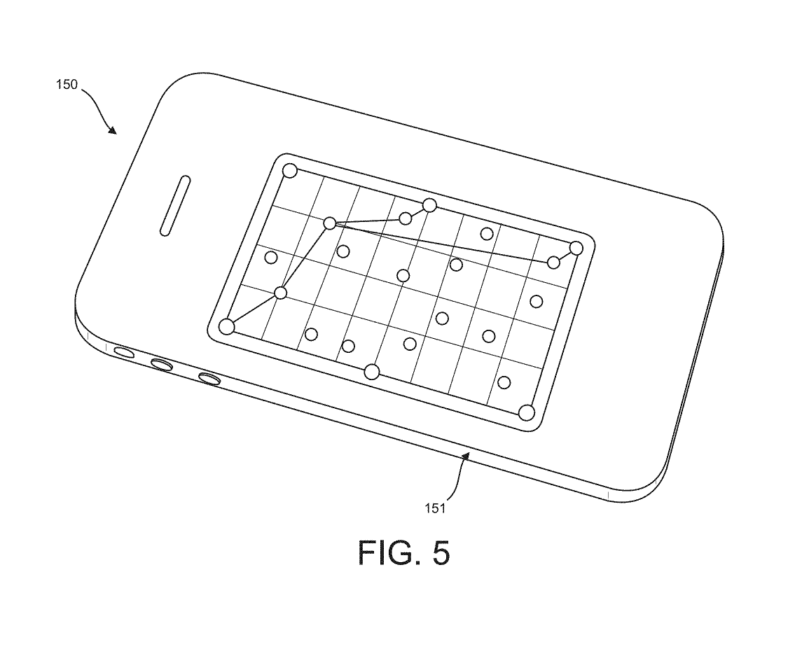

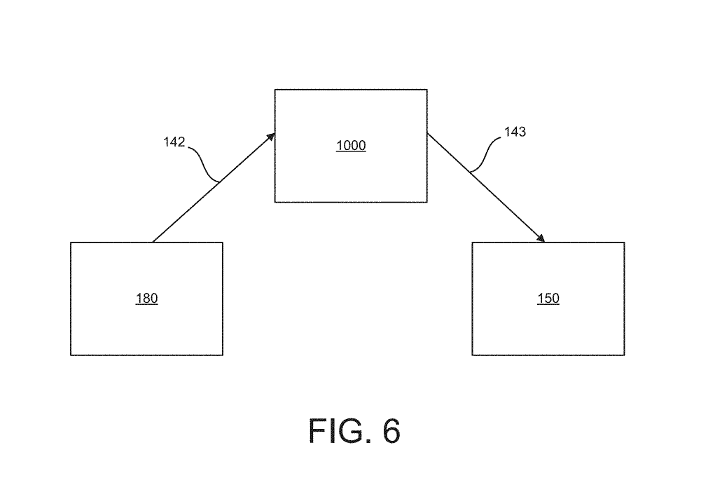

Referring to FIGS. 1-6, a billiard aiming system 1000 is configured for use with a billiards table 180 having a playing surface 181 and a mobile device 150. The billiard aiming system 1000 may be used with any billiards table 180. For example, the standard settings of the billiard aiming system 1000 may be pre-set to recognize the length and width of a regulation standard 8 ft billiards table (88 inches long×44 inches wide) with the option to allow the user to enter different dimensions (e.g., a standard 9 ft billiards table—100 inches long×50 inches wide) manually or through software (e.g., an application) installed on the mobile device 150. The playing surface 181 of the billiards table is defined by a rectangular frame and may include indicators 182, usually diamonds or dots, inlaid into the frame. On a pockets billiard table, the indicators 182 may be intentionally situated in-between the six pockets located about the perimeter of the playing surface 181. Typically, there are a total of eighteen indicators 182 located along the perimeter of the playing surface 181—three indicators situated in-between each one of the six pockets. These indicators 182 serve to assist in choosing the proper angles for shots such as kick shots and bank shots. When used correctly, a player can utilize the location of the indicators 182 as a reference point to calculate or visualize the precise impact point to send a cue ball or object ball on the billiards table 180 to achieve a desired result. The relative orientation of these indicators 182 may vary depending on of the billiards table 180.

The mobile device 150 may be, for example, a smartphone, a tablet, a personal digital assistant (PDA), a laptop, etc. One or more mobile devices 150 may be in communication with the billiard aiming system 1000 at any given time via any known wireless communication technology (e.g., WiFi, WLAN, Bluetooth, etc.). A user can manually enter a serial number provided on the billiard aiming system 1000 into the mobile device 150 to establish the connection, or the mobile device 150 may automatically detect the billiard aiming system 1000 and ask the user if he/she would like to connect the mobile device 150 to the billiard aiming system 1000. In some examples, the billiard aiming system 1000 may be connected to a router via a wired (e.g., Ethernet cable) or wireless connection to establish an Internet connection.

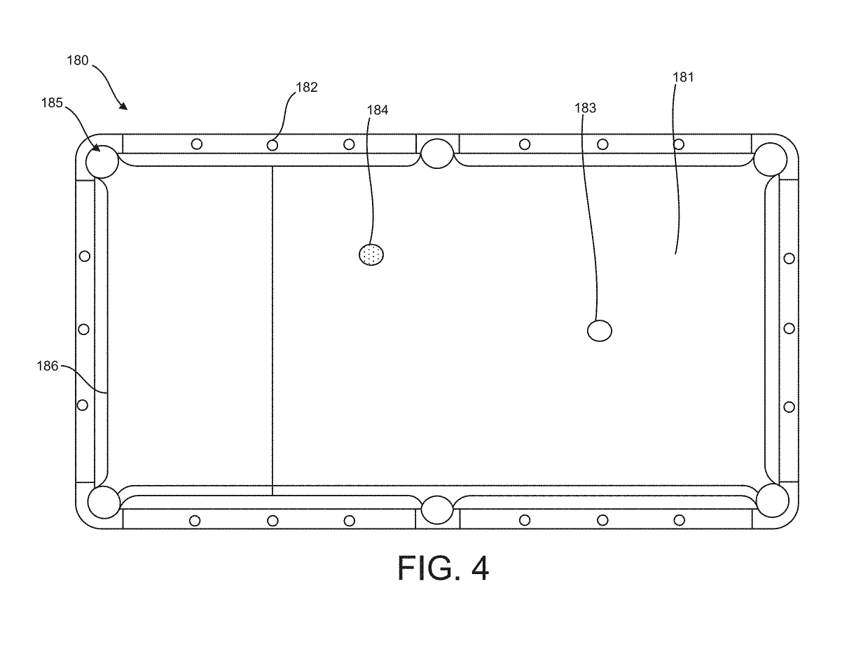

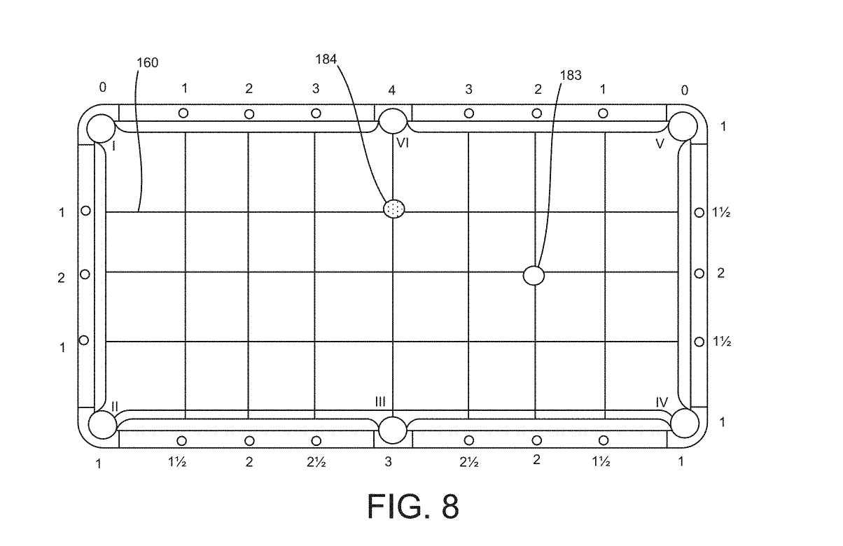

The billiard aiming system 1000 includes a housing 100 that contains a projector 110 and at least one sensor 120 configured to detect the billiards table 180 and the presence of one or more objects (e.g., a cue ball, an object ball, a striker ball, etc.) on the billiards table 180. The at least one sensor 120 may be, for example, a line sensor, a light sensor, an infrared sensor, an ultrasonic sensor, a color sensor, an image sensor (e.g., camera, digital camera, CCD camera, CMOS camera, etc.), or a combination thereof. In some examples, the housing 100 may contain an array of sensors 120. The projector 110 is configured to project an image, for example, an instructional grid 160, directly onto the playing surface 181 of the billiards table 180 and is mountable to a support surface 113, such as a ceiling or a wall, via a projector mount 112. The support surface 113 may be parallel to the playing surface 181 or at an angle that is not parallel to the playing surface 181. In some examples, the projector 110 projects the grid 160 using a light source and an optical lens. In other examples, the projector 110 projects the grid 160 directly using a laser. Referring to FIG. 8, the grid 160 may be, for example, based on the position of the indicators (labeled 182 in FIG. 4) and/or pockets (labeled 185 in FIG. 4). The image projected by the projector 110 may include one or more colors.

The grid 160 includes an optional numbering system to facilitate learning. In the numbering system, the numbers on opposing rails vary by different increments. In the example of FIG. 8, the upper left pocket and the upper right pocket are assigned the number “0”. From left to right, the indicators of the upper rail are numbered 1, 2, 3, 4 (the center pocket), 3, 2, 1. In other words, on the upper rail, the numbers increase by a first predetermined increment (in this example, an increment of 1) between a first pocket (left pocket) and a midpoint (the center pocket) of the first rail, and then decrease by the first predetermined increment between the midpoint and a second pocket (right pocket) of the first rail. In the same example, the lower left pocket and the lower right pocket are assigned the number “1”. From left to right, the indicators of the lower rail are numbered 1.5, 2, 2.5, 3 (the center pocket), 2.5, 2, 1.5. In other words, on the lower rail, the numbers increase by a second predetermined increment (in this example, an increment of 0.5) between a first pocket (left pocket) and a midpoint (center pocket) of the lower rail, and then decrease by the second predetermined increment between the midpoint and a second pocket (right pocket) of the lower rail. The first predetermined increment and the second predetermined increment are not equal. In addition to projecting the grid 160, the projector 110 may optionally project a numerical calculation to help the player understand where to hit the cue ball 183 to sink the object ball 184 in a particular pocket. In addition, or as an alternative, the numerical calculation may be displayed on the mobile device 150. Referring to FIG. 8, the numerical calculation may be, for example, “2+3=5” where 2 is the position of the cue ball 183 with respect to the numbering on the lower rail and 3 is the position of the marker on the upper rail where the object ball 184 should be hit to sink the object ball 184 in the lower left pocket.

The billiard aiming system 1000 further includes a computing system 170 (described in further detail below) configured to provide the mobile device 150 with information related to the presence of one or more objects on the billiards table 180. The mobile device 150 is configured to display information obtained from the computing system 170 and information related to potential shot trajectories on a user interface.

The at least one sensor 120 is configured to capture geometric and identification data of one or more objects on the playing surface 181 of the billiards table 180 such as the location of at least one indicator 182, end line 186, cue ball 183, object ball 184, pocket 185 or any combination thereof. The geometric and identification data obtained from the at least one sensor 120 are then communicated to a computing system 170 including a processor 140, a non-transitory memory 141, a logic unit 146, and a communication module 147 (i.e., a transmitter and a receiver, or a transceiver). The processor 140 is programmed to receive input data 142 from the at least one sensor 120, to follow instructions from the logic unit 146 to convert the input data 142 collected by the at least one sensor 120 into output data 143 that is sent by the communication module 147 to the mobile device 150. The communication module 147 is configured to wirelessly transmit the information to the mobile device 150 via any known wireless communication technology e Wi Bluetooth, etc.). An application on the mobile device 150 is configured to display suggested shot trajectories on a graphical user interface 151.

Method of Use

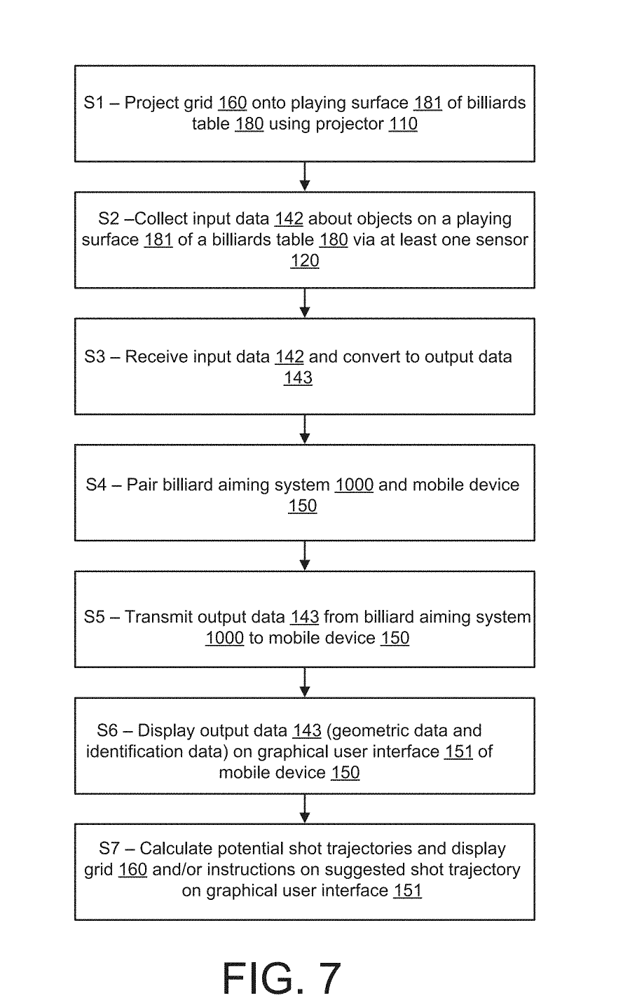

Referring to FIGS. 7 and 8, a method of using the interactive billiard aiming system 1000 includes a Step 51 of projecting the grid 160 onto the playing surface 181 of the billiards table 180 using the projector 110. In Step S2, input data 142 is collected via the at least one sensor 120. The input data 142 may include information corresponding to geometric data and identification data. The geometric data relates to the location of one or more indicators 182, the cue ball 183, one or more object balls 184, and/or one or more pockets 185. The identification data relates to the identity of the one or more indicators 182, the cue ball 183, the one or more object balls 184, and/or the one or more pockets 185. In a Step S3, the input data 142 is received by the computing device 170 (in particular, the processor 140) and converted into output data 143. In a Step S4, the billiard aiming system 1000 is paired with the mobile device 150. The Step S4 may optionally be performed before any of Steps S1-S3. In a Step S5, the output data 143 is transmitted by the communication module 147 of the billiard aiming system 1000 to the mobile device 150. In a Step S6, the application on the mobile device 150 displays the geometric data and the identification data on a graphical user interface 151 and allows the user to select the desired action. For example, the user may select the size of the billiards table 180, the type of billiards game being played, a particular object ball 184 that the user would like to hit with the cue ball 183 and sink in a pocket 185, and/or a particular object ball 184 that the user would like to hit with the striker ball. In a Step S7, the application on the mobile device 150 calculates and suggests potential shot trajectories, and displays instructions for a potential shot trajectory on the graphical user interface 151. Referring to the example of FIG. 8, in addition to the numbering system described above (or as an alternative to the numbering system), the projector 110 may project or the mobile device 150 may display a visual indicator (e.g., a small red circle) on the cue ball 183 and/or the object ball 184, suggesting where the player should strike the cue to the cue ball 183 or strike the cue ball 183 to the object ball 184. In addition, or as an alternative, the mobile device 150 may also provide verbal instructions including tips such as the suggested force to strike with, which marker to target, etc. In other words, the projector 110 and/or the mobile device 150 may display the numbering system, display the visual indicator on the cue ball 183 and/or the object ball 184, provide verbal instructions, or any combination thereof. The mobile device 150 may also illustrate the shot trajectory on a grid on the graphical user interface 151, the grid corresponding to the grid projected onto the surface 181 of the billiards table 180 by the projector 110. The shot trajectory is not projected onto the surface 181 of the billiards table 180.

In Step S7, the application on the mobile device 150 calculates and suggests potential shot trajectories based on the location of the objects on the playing surface 181 and various equations related to momentum, kinetic energy, angular velocity, etc. stored therein. For example, referring to the cue ball 183 as ball A for simplicity and the object ball 184 as ball B for simplicity, the general equation for conservation of linear momentum of the colliding balls may be calculated according to Equation 1:

m_{A\vec{V}}_{1A}=m_{A}\vec{V}_{2A}+mₛ\vec{V}_{2B} (1)

where m_{A} is the mass of the cue ball, m_{B} is the mass of the object ball, V_{1A} is the initial velocity of the cue ball, V_{2A} is the velocity of the cue ball after impact with the object ball, and V_{2B} is the velocity of the object ball after impact with the cue ball. For an elastic collision, kinetic energy is conserved according to Equation 2:

½m_{A}(V_{1A})²=½m_{A}(V_{2A})²+½m_{B}(V_{2B})² (2)

In general, it can be assumed that the cue ball and the object ball have the same mass, such that formula 2 simplifies to Equation 3:

(V_{1A})²=(V_{2A})²+(V_{2B})² (3)

and that the object ball 184 is initially at rest (zero velocity). The initial velocity of ball A is V_{1A}. After impact, ball A moves at velocity V_{2A} in the direction shown, and ball B moves at velocity V_{2B} in the direction shown. Using these equations, coupled with geometric equations such as the Pythagorean theorem, the application on the mobile device 150 provides instructions for the angle and speed at which the cue ball 183 should impact the object ball 184. For example, where the object ball 184 is hit at an angle close to zero, the cue ball needs be moving at a high speed V_{1A} (i.e., the user should hit the cue ball 183 hard to apply a large force) because only a small fraction of the momentum (and therefore velocity) of the cue ball 183 is transferred to the object ball 184 due to the obliqueness of the impact. In cases where the cue ball 183 impacts a center of the object ball 184 (impact is head on), the momentum (and therefore velocity) of the cue ball 183 is completely transferred to the object ball 184 (V_{2A}=0 and V_{2B}=V_{1A}) such that the user can hit the cue ball 183 with less force than in the previous example. The equations relied upon by the application on the mobile device 150 may also take into account friction between the cue ball/object ball and the playing surface. These equations are non-limiting examples of formulas that may be used by the application.

In some aspects of the billiard aiming system 1000, the computing device 170 includes a non-transitory memory 141 configured to store the input data 142 obtained from the sensor 120. The non-transitory memory 141 may be located inside or remotely located outside of the housing 100. Alternatively, or in addition, the output data 143 may be stored in a non-transitory memory on the mobile device 150. The stored input data 142 and/or output data 143 may be used to enhance the accuracy in calculating potential shot trajectories.

Machine learning or artificial intelligence may be used to take into account user traits, for example, a tendency of the user to hit the cue ball off-center or with too little force, to compensate for or provide additional suggestions in the suggested shot trajectories. A suggested shot trajectory is governed by a number of variables including but not limited to user input variables, variables stored in the non-transitory memory 141, identification variables, and/or geometric variables. User input variables correspond to information such as the type of game being played, the skill level of a given user, or the desired result of a user for a particular shot. Variables stored in the non-transitory memory 141 correspond to information such as the coefficient of friction of the playing surface 181 or the rebounding effect of the raised rails (i.e., the frame) surrounding the perimeter of the playing surface 181. Identification variables correspond to information that relates to the identity of billiard balls and tables elements. For example, the object balls 184 are typically identified by number, color, and marking. The two typical subsets of markings of the object balls 184 are stripes and solids. Geometric variables correspond to the location of elements contained along the playing surface 181 of the billiards table 180.

The user input variables, variables stored in the non-transitory memory 141, identification variables, and/or geometric variables may be used to calculate, among other things, the requisite shot force, shot angle relative to instructional grid 160, and linear and angular velocities of the cue ball 183. The identification of an element such as an object ball 184 for example, may be important in in different ways in different types of games. Therefore, a suggested shot trajectory may differ depending on the type of game being played or the classification of a ball as stripes or solids. Additionally, these variables also necessary to predict the effect of collisions between the cue ball 183, the object balls 184, and the end lines 186.

In some examples, the application on the mobile device 150 allows the user to connect with other users of the application. For example, the application may allow users to friend each other, chat with each other, follow each other, upload/view pictures or videos, etc. Information regarding a particular user's statistics (e.g., shots made or missed following the instructions provided by the application, common mistakes, etc.) may be uploaded to a central database that stores each user's statistics and used to enhance the predictive capabilities of the application, in particular, machine learning or artificial intelligence software.

The billiard aiming system 1000 described above projects an instructional grid directly onto the playing surface of a billiards table to facilitate teaching the basics of playing billiards. The billiards aiming system offers an interactive way to master billiards. By providing instant feedback to allow a user to quickly learn from their mistakes and to provide novices with a visual aid to facilitate learning essential techniques needed to proficiently pocket an object ball, with consistency, in a very short period of time.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

It should be noted that the orientation of various elements may differ according to other exemplary embodiments, and that such variations are intended to be encompassed by the present disclosure.

The operations described above may be executed by a computer programmed to perform the steps of the algorithm. Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display), OLED (organic light emitting diode), TFT (thin-film transistor), plasma, other flexible configuration, or any other monitor for displaying information to the user and a keyboard, a pointing device, e.g., a mouse trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

What is claimed is:

1. A billiard aiming system comprising:
a housing configured to be mounted to a ceiling above a billiards table;
at least one sensor positioned within the housing, the at least one sensor configured to detect a position and an identity of at least one object on a playing surface of the billiards table; and
a projector positioned in visual communication with the billiards table, the projector configured to project a grid on the playing surface of the billiards table.

2. The billiard aiming system of claim 1, wherein the at least one sensor comprises a line sensor, a light sensor, an infrared sensor, an ultrasonic sensor, a color sensor, an image sensor, or a combination thereof

3. The billiard aiming system of claim 2, wherein the at least one sensor is configured to detect a color and a pattern of the at least one object on the playing surface of the billiards table.

4. The billiard aiming system of claim 2, wherein the pattern comprises a solid pattern or a striped pattern.

5. A system for teaching billiards comprising:
a billiards table having a playing surface;
a billiard aiming system comprising:
a housing configured to be mounted to a ceiling above the billiards table;
at least one sensor positioned within the housing, the at least one sensor configured to detect a position and an identity of at least one object on the playing surface of the billiards table; and
a projector positioned in visual communication with the billiards table, the projector configured to project a grid on the playing surface of the billiards table; and
a mobile device having a graphical user interface, the mobile device being configured to receive geometric data and identification data from the billiard aiming system and display instructions regarding a suggested shot trajectory on the graphical user interface based on the geometric data and the identification data.

6. The system of claim 5, wherein the at least one sensor comprises a line sensor, a light sensor, an infrared sensor, an ultrasonic sensor, a color sensor, an image sensor, or a combination thereof.

7. The system of claim 5, wherein
the billiards table includes a plurality of indicators and a plurality of pockets spaced along a periphery of the billiards table,
the at least one sensor is configured to detect the location and the identity of a plurality of objects on the playing surface of the billiards table, the objects comprising at least one object ball and a cue ball,
the geometric data comprises a position of at least one of the indicators, the cue ball, the at least one object ball, or the pockets.

8. The system of claim 7, wherein the identification data comprises a color and a pattern of the cue ball or the at least one object ball.

9. The system of claim 8, wherein the pattern comprises a solid pattern or a striped pattern.

10. The system of claim 5, wherein a size and a shape of the grid is adjustable to cover the playing surface of the billiards table.

11. The system of claim 5, wherein:
the projector is further configured to project a numbering system on at least a first rail of the billiards table and a second rail of the billiards table opposite to the first rail,
numbers on the first rail increase from a first pocket of the first rail to a midpoint of the first rail by a first predetermined increment, and decrease from the midpoint of the first rail to a second pocket of the first rail by the first predetermined increment,
numbers on the second rail increase from a first pocket of the second rail to a midpoint of the second rail by a second predetermined increment, and decrease from the midpoint of the second rail to a second pocket of the second rail by the second predetermined increment, and
the first predetermined increment is not equal to the second predetermined increment.

12. The system of claim 5, wherein the billiard aiming system is configured to communicate the geometric data and the identification data to the mobile device through a wireless connection.

13. A method of operating a billiard aiming system, comprising the steps of:
projecting a grid onto a playing surface of a billiards table using a projector positioned in visual communication with the billiards table;
detecting geometric data and identification data using at least one sensor positioned within a housing mounted to a ceiling above the billiards table;
transmitting the geometric data and identification data to a processor in a mobile device;
processing, using the processor, the geometric data and identification data to identify a suggested shot trajectory; and
displaying instructions regarding the suggested shot trajectory on a display of the user device.

14. The method of claim 13, wherein the at least one sensor used to detect the geometric data and the identification data comprises a line sensor, a light sensor, an infrared sensor, an ultrasonic sensor, a color sensor, an image sensor, or a combination thereof.

15. The method of claim 13, the step of displaying instructions comprises identifying gridlines of the grid to be used to line up a shot.

16. The method of claim 13, wherein detecting geometric data and identification data comprises detecting a location and an identity of a plurality of objects on the playing surface of the billiards table, the objects comprising at least one object ball and a cue ball.

17. The method of claim 16, wherein:
the billiards table includes a plurality of indicators and a plurality of pockets spaced along a periphery of the billiards table, and
detecting geometric data further comprises detecting a position of at least one of the indicators or the pockets.

18. The method of claim 16, wherein:
the identification data comprises a color and a pattern of the cue ball or the at least one object ball, and
the pattern comprises a solid pattern or a striped pattern.

19. The method of claim 13, wherein processing the geometric data and identification data comprises using machine learning or artificial intelligence to identify the suggested shot trajectory.

20. The method of claim 13, further comprising projecting a numbering system on at least a first rail of the billiards table and a second rail of the billiards table opposite to the first rail, wherein:
numbers on the first rail increase from a first pocket of the first rail to a midpoint of the first rail by a first predetermined increment, and decrease from the midpoint of the first rail to a second pocket of the first rail by the first predetermined increment,
numbers on the second rail increase from a first pocket of the second rail to a midpoint of the second rail by a second predetermined increment, and decrease from the midpoint of the second rail to a second pocket of the second rail by the second predetermined increment, and
the first predetermined increment is not equal to the second predetermined increment.
